(19) United States
(12) Patent Application Publication
(10) Pub. No.: US 2005/0204542 A1
(43) Pub. Date: Sep. 22, 2005

(54) Cylinder head stud removal tool

(76) Inventor: Bernard Pittman, Milk River (CA)

Correspondence Address: SEAN W. GOODWIN, 237- 8TH AVE. S.E., SUITE 360, THE BURNS BUILDING, CALGARY, AB, T2G 5C3, CA

(21) Appl. No.: 10/801,708

(22) Filed: Mar. 17, 2004

(51) Int. Cl. B23P 23/00

(52) U.S. Cl. 29/566

(57) ABSTRACT

A method and apparatus for the removal of a broken stud from a cylinder head, and rehabilitation thereof, includes a precise alignment block for attachment to at least two intact studs or stud bores of a cylinder head for alignment of a pilot port over the broken stud. Further holes in the block along the length of the block match a stud pattern of a cylinder head of pre-determined stud spacing. The apparatus comprises a series of replaceable steady pilots and corresponding rotary tools in pairs, including an end mill and cooperating milling pilot for flat or concave milling of the end of the broken stud; a drill bit and cooperating drilling pilot for drilling the end of the broken stud; and a tap and cooperating threaded tapping pilot to form new threads in the cylinder head for accepting a new replacement stud. Optionally, a threaded coil insert can be used in the newly prepared stud bore, having outer threads matching the new threads and having inner threads matching a replacement stud.

### FIELD OF THE INVENTION

This invention relates to automotive tools, more specifically to a method and apparatus to remove a broken cylinder head stud and to prepare a stud bore for a replacement stud.

### BACKGROUND OF THE INVENTION

Stud breakage in cylinder heads is a well-known problem and typically occurs with exposure to severe heat over time and subsequent attempts at removal. Most commonly, the threaded fastener such as a stud nearest the firewall is prone to breakage, as it is exposed to the highest degree of heat. When a stud bolt breaks off in the cylinder head, it leaves in the threaded bore a threaded portion which must be removed prior to insertion of a new stud. Due to restricted and tight access to the broken stud in the engine compartment, typically the entire cylinder head is removed from the vehicle and is repaired at a bench utilizing, among other tools, including and drill press and extractors. This process is time consuming and can requiring days for this service.

Others have contemplated providing jigs or drill guides for removal of broken studs for other uses. Some having a series of pilots adapted for rotary tools, and others aligning a hole over a broken stud by bolting onto two remaining studs.

For instance, in another instance of automobile maintenance, others have modified an engine timing case to include a perpendicular locking bolt to secure a dowel alignment. As suggested by a Doge Truck enthusiast at a web page www.dodgeraw.org, a jig includes an alignment block with two parallel holes to secure a guide plate to a flange attachment to the timing case. A third hole perpendicular to the first two holes accepts removable and interchangeable steady pilots. The pilot holes or guides are adapted for a variety of different rotary tools such as a drill, tap, and counter sink. The intact flange is drilled, tapped and countersunk for accepting a dowel pin locking bolt. The procedure is not to replace a broken component but to add a bolt where none existed previously.

Others have applied three-hole jigs to remove broken studs including drilling a jig hole for removal of a broken axle-end studs using two other intact studs. A drill and an extractor are applied. Applicant is not aware of such devices including means for replacement of the stud.

A device is needed that provides precise alignment over a broken cylinder head stud, while providing the tools to not only effectively remove the broken stud, but to adequately prepare the stud bore for insertion of a new stud.

### SUMMARY OF THE INVENTION

An alignment block attaches to a cylinder head and acts as a precise guide to efficiently remove a broken stud in a stud bore of the cylinder head while the cylinder head remains in the vehicle. The alignment block also allows for the preparation of the stud bore for insertion of a new intact stud. Herein, the term stud applies equally to the use of threaded fasteners including studs and cap screws and one, or the other, or both may be used or substituted throughout.

Broadly, a tool for removal of a broken stud in a stud bore of a cylinder head, and rehabilitation thereof, comprises an alignment block adapted for attachment to at least two intact stud bores of a cylinder head. At least one pilot port is located in the block for alignment over the broken stud. A series of steady pilots for removing the broken stud and rehabilitating the stud bore, are removeably secured to the pilot port. A series of rotary tools correspond to the steady pilots and form pairs, the rotary tools for removal of the broken stud from the stud bore, and rehabilitation thereof. The series of pilot and rotary tool pairs comprise an end mill and cooperating milling pilot for flat or concave milling of the end of the broken stud; a drill bit and cooperating drilling pilot for drilling the end of the broken stud; and a tap and cooperating threaded tapping pilot to form new threads in the cylinder head.

Preferably, the tap forms oversized threads for installation of a coiled insert into the stud bore. The shape of the alignment block is an elongate, running a length of the cylinder head. A full or partial block member are available and comprise at least 2 holes for securing to two intact studs or stud bores, and at least one hole acting as a pilot port and aligning over the broken stud.

In one aspect, a process for removal of a broken stud in a stud bore of a cylinder head, and rehabilitation thereof, comprises the steps of removing an exhaust manifold to reveal the broken stud and the intact bores or studs; fitting an alignment block over at least two intact studs, or stud bores, and securing in place the alignment block over at least two stud bores, or stud bores, in the cylinder head and securing in place through holes in the alignment block, such that a pilot port in the block is aligned over the broken stud; installing a milling pilot to the pilot port and milling using a cooperating end mill for flat or concave milling of the end of the broken stud; installing a drilling pilot to the pilot port and drilling using a cooperating drill bit to remove the stud and threads for drilling the end of the broken stud; installing a tapping pilot to the pilot port and tapping the stud bore using a cooperating tap to form new threads in the stud bore; and fitting a replacement stud into the rehabilitated stud bore.

More preferably, the process further comprises inserting a coiled insert into the stud bore, after the tapping step, the coiled insert having outer threads matching the new threads and having inner threads matching a replacement stud.

### BRIEF DESCRIPTION OF THE DRAWINGS

FIG. 1 is an example of a prior art repair of a cylinder head utilizing removal from the vehicle and extraction of broken bolt at a drill press;

FIG. 2 is a perspective view of a cylinder head such as that from a Chevrolet 350 cu/in engine and jigs according to two embodiments of the invention, either a short length, rotatable jig and a singe long jig plate suitable for the entire head;

FIG. 3 is a perspective view of a cylinder head, intact bolts and a broken bolt awkwardly positioned adjacent a vehicle firewall;

FIG. 4 is an exploded top view showing the short length jig of FIG. 2 aligned with the head of FIG. 3 and further illustrating a sequence of pilots and rotary tool pairs used to remove and replace the broken stud; and

FIG. 5 is a perspective view of a vehicle engine compartment requiring exhaust stud extraction using a preferred embodiment of the invention to remove the broken stud.

### DETAILED DESCRIPTION OF THE PREFERRED EMBODIMENT

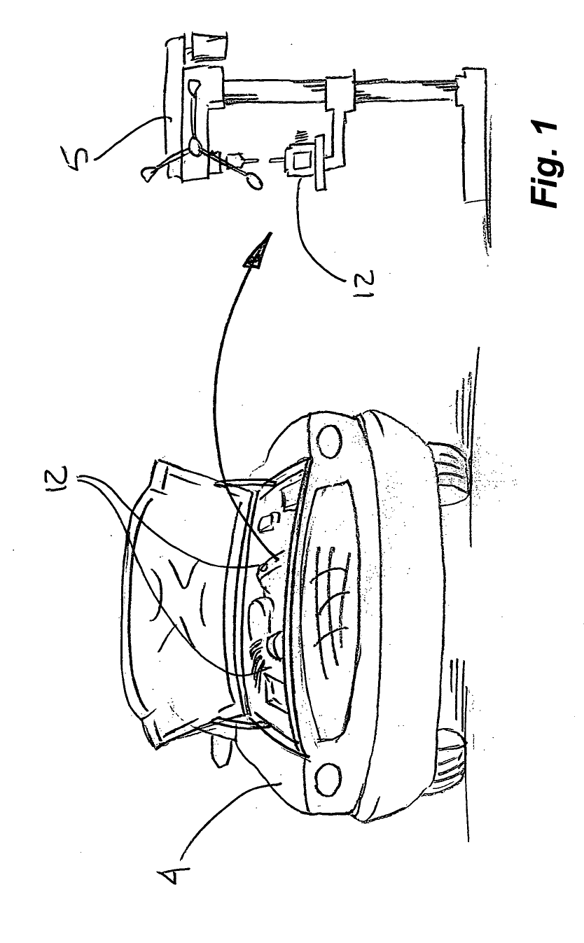

With reference to FIG. 1, a conventional prior art technique involves a labor intensive removal of a cylinder head 12 from the vehicle 4 for repair on the bench including use of a drill press 5 and then a re-installation of the head on the vehicle, including use of new head gaskets.

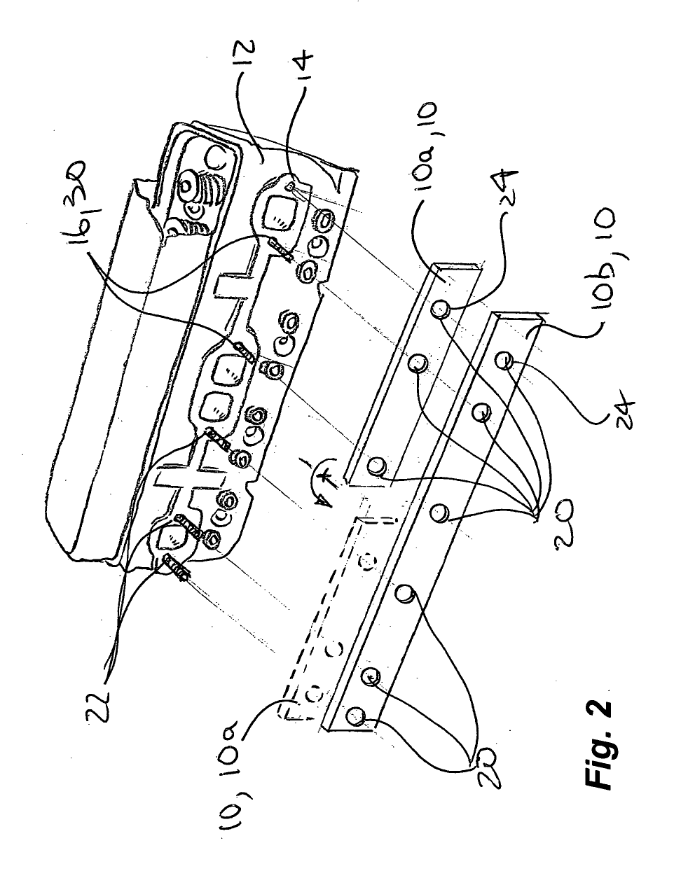

With reference to FIGS. 2-5, embodiments of the invention are illustrated for ease of repair on the bench or the head can remain in the vehicle and increasing productivity by increasing the efficiency of the process.

In either instance, an alignment block 10 removeably attaches to a cylinder head 12 and aids in providing a precise guide to efficiently remove a broken threaded fastener 30 such as the broken threaded end 14 of a stud 30 or cap screw 30b in a stud bore 16 of the cylinder head 12. The invention also allows for the preparation of the stud bore 16 for insertion of a replacement fastener 54.

As shown in FIG. 2, alignment block members 18 are provided and which are adapted to a particular cylinder head 12 having known pre-determined spacing of studs 30 (although Chevrolet typically uses cap screws 30b) fit to intact stud bores 16. A short length alignment member or block 10a is adapted with a minimum of three holes 20. The holes 20 are spaced to fit a particular cylinder head 12. A head from a particular line of Ford Motors heads will have one pattern 33 and those from a different Ford engine or those from a Chevrolet engine will have a different spacing. There are a finite number of engine and head patterns 22. As shown in FIG. 2, a short block 10a fits a stud pattern 22 of a Chevrolet 350 cylinder head, or another cylinder head carrying the same stud pattern 22. Similarly, a larger full length alignment block 10b can be implemented and which extends along the entire head 12. Any one of the holes 20 of an alignment block 10 can act as a pilot port 24 as a broken stud 14 may appear at any one of the locations on the head. Other combinations of alignment blocks can be provided having lesser or greater numbers and arrangements of holes 20.

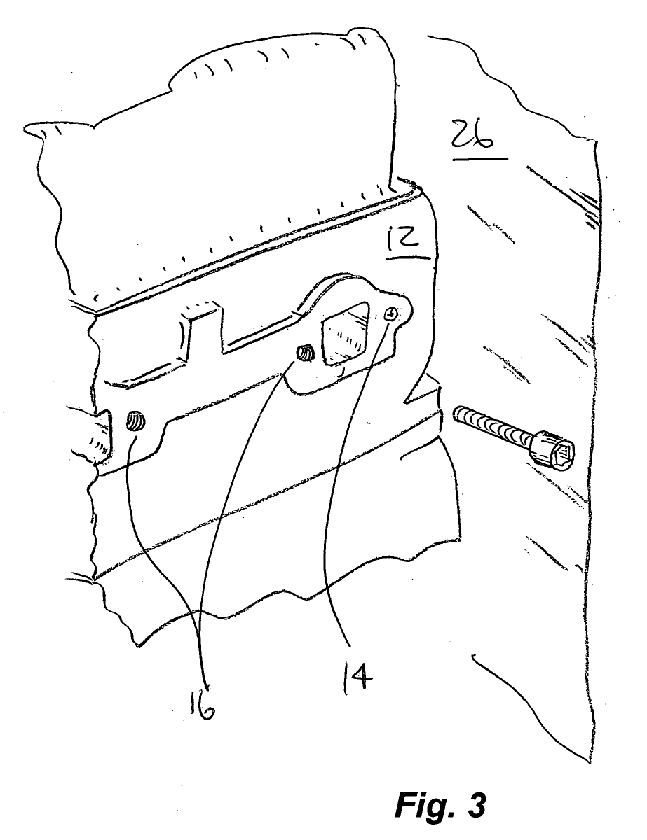

As shown in FIG. 3, one can see that after removal of the exhaust manifold and any other interferences, the broken threaded end 14 is typically the last stud nearest a firewall 26.

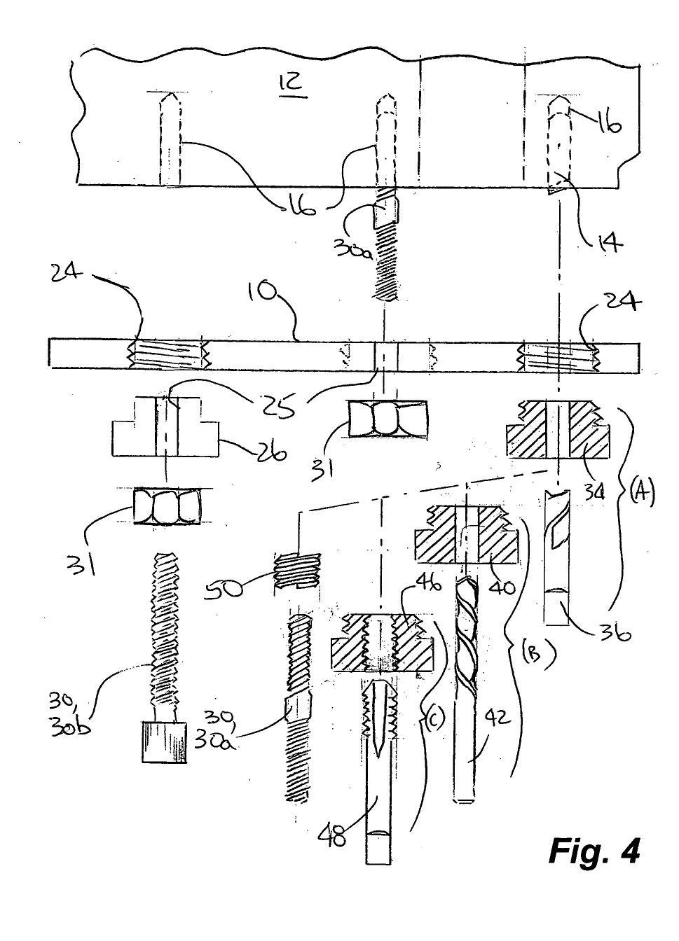

With reference to FIG. 4, a series of steady pilot and rotary tool pairs 28 (A-C) correspond with the pilot port 24, and removeably attach to the pilot port 24 for removal of the broken threaded end 14 and preparation of the stud bore 16 for a replacement stud 54.

The alignment block 10 acts as a base plate and securely attaches to a clean surface of the cylinder head 12. At least two holes 20 in the alignment block 10 fit over two sound or intact studs 30, or intact stud bores 16, while the pilot port 24 aligns over the broken stud 14. A short alignment block 10 is shown and is illustrated with at least one threaded pilot port 24. All three holes may be threaded (two outside holes shown for illustration) so as to alternatively acting as a pilot port 24 or as a mere bolting port 25 (middle hole shown with dotted lines for an optional threaded port 24, or the solid line option for a mere bolting port 25). Accordingly, a bolting/pilot port 25,24 can include a bolting pilot 26 for close fit to an intact stud bore 16 and stud 30a or cap screw 30b for precise aligning of the alignment block 10. Optionally, the alignment block 10 may have only one pilot port 24, and at least two bolting ports 25 (illustrated with one bolting/pilot port 25,24 and one solely acting as a bolting port 25) which are sized to the existing and intact studs. Such an alignment block would be suitable only for repair at one stud location.

As shown, the alignment block 10 is secured to each of the two intact studs 30, or stud bores 16 with suitable means, such as a nut 31, or where the intact stud has already been removed then with a cap screw 30b or bolt (not shown), respectively.

The pilot port 24 in the block 10 accepts a series of pilot and rotary tool pairs (also shown in FIG. 4). Two pairs (A,B) aid in the removal of the broken stud, while a third pair (C) prepares the stud bore for a replacement fastener 54.

The first pair of tools (A) is a milling pilot 34 and an end mill 36. This tool pair (A) is used to remove a small amount of the broken threaded end 14, squaring off the exposed end of the broken threaded end 14 for preparation for the next step. The second pair of tools (B) is a drilling pilot 40 and a drill bit 42. Precise drilling can commence at the milled face. This tool pair (B) allows the broken threaded end 14 to be drilled out of the head. Preferably, a left-hand (LH) drill bit is used to aid in removal of the broken threaded end 14. Usually the technician will note the milling and drilling depth due to a change in resistance, however, depth gauges or tools of limited length may be used to avoid over drilling.

Clearly in some cases, early in the drilling step, the LH bit will break the broken stud free of the head and extract it without the need for further repair. In such cases, only a replacement fastener 54 need be re-installed. However typically, the broken threaded end 14 will not yield so easily. Accordingly, the drill bit 42 drills out the broken threaded end 14 and at least a portion of the threads of the stud bore 16, resulting in an oversize hole.

Thus, the third and final tool pair (C) is a tapping pilot 46 and a tap 48. The tap 48 is slowly rotated down into the now empty stud bore 16, re-threading the stud bore 16 to allow for the insertion of a threaded coiled insert 50, such as a Heli-coil™, which fits the oversized threaded stud bore 16 and accepts a new standard size stud 30b. It is possible to use a custom stud having an oversized root diameter for threading into the oversize hole, but is more usual to use the insert and a standard stud 30.

Each pilot 34,40,46 is secure as it threads into the pilot port 24 to ensure the correct alignment of its corresponding rotary tool 36,42,48. The tool pairs (A), (B), and (C) ensure the drilling and tapping are precise and permit reinstallation of the intact stud and exhaust manifold after repair. The rotary tools 36,42,48 attach to a rotary drive tool (not shown), such as a drill.

Referring back to FIG. 2, an alternative embodiment of the invention is to have a longer or even a full length alignment block 10 with enough holes 20 to provide access to all stud bores 16 in the cylinder head 12. Similarly, this option provides at least two holes 20 for securing the block 10 to the cylinder head 12, while all other holes 20 align over other intact or broken studs 14. All holes 20 can act as pilot ports 24 allowing the series of pilots and rotary tool pairs (A)-(C) to access any one of the stud bores 16 in the cylinder head 12.

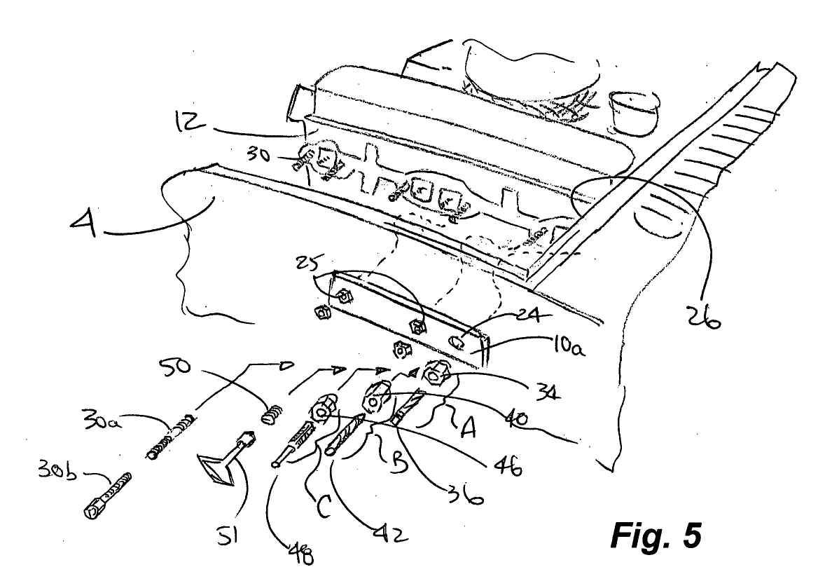

The process for in-the-vehicle repair is best shown in FIG. 5. To attach the alignment block 10 to the cylinder head 12, an exhaust manifold is removed to reveal the cylinder head 12 containing the broken stud 14, as well as the intact studs 30. Once the exhaust manifold is removed the surface of the cylinder head 12 may be cleaned of residual gasket material as necessary. As previously described, the alignment block 10 is mounted to the cylinder head 12 such that the pilot port 24 is over the broken stud 14. The other 20 holes are fit with bolting pilots 25 as necessary secured to intact studs or stud bores 30 using suitable bolts.

The milling pilot 34 is first threaded into the pilot port 24. The mill 36 is installed in a rotary drive tool (not shown). The mill 36 is stabilized by the milling pilot 34 and the rotary drive tool to protect the stud bore 16 from damage by ensuring the broken threaded end 14 is milled along its major axis. The milling pilot 34 accurately guides the mill 36 such that it is in square and axial alignment with the broken threaded end 14. Once the accessible surface of the broken threaded end 14 is relatively flat, or concave, the mill 36 and then milling pilot 34 are removed from the pilot port 24.

The drilling pilot 40 is now threaded into the pilot port 24 to replace the milling pilot 34. The drill bit 42 is installed in the rotary drive tool. The stud bore 16 is protected and the drill bit 42 is guided as described above for the milling process. The drill bit 42 is preferably left-handed allowing the bit 42 to aid in an early extraction of the broken threaded end 14 as discussed previously for extraction of a broken stud 14 without the need for further drilling or the conventional extraction tool.

In cases where the stud bore 16 is drilled, the drill bit 42 and drilling pilot 40 can be removed from the pilot port 24.

The tapping pilot 46 is now threaded into pilot port 24. The tap 48, such as a Heli-coil™ STI tap, is rotated into the tapping pilot 24 and carefully rotated down into the oversize stud bore 16 using an appropriate socket and ratchet, or other similar drive tool. A forward and backward motion of the tap 48 as it is slowly rotated into the stud bore 16 creates new threads along the stud bore 16. Once the stub bore 16 has been re-threaded, the cuttings are cleared away and the tap 48 and tapping pilot 46 are removed from the pilot port 24.

The tap 48 creates oversized threads in the stud bore 16. In such a situation, a coiled insert 50, such as a commercially available Heli-Coil™, is threaded down into the newly threaded stud bore 16, the coiled insert 50 having outer threads matching the new threads and having inner threads matching a replacement fastener 54.

A suitable hand tool 51 is employed to drive the Heli-coil™ into the threaded stud bore 16. The coiled insert 50 accommodates a standard bolt or stud. The alignment block 10 is removed from the cylinder head 12 and a new, intact stud is installed in the rehabilitated stud bore 16. One could also remove the alignment block 10 before inserting the Heli-coil™ as this is a matter of convenience and mechanic preference.

1. A tool for removal of a broken threaded fastener in a stud bore of a cylinder head, and rehabilitation thereof, the tool comprising:
an alignment block adapted for attachment at least two intact stud bores of a cylinder head;
at least one pilot port located in the alignment block for alignment over the broken stud;
a series of steady pilots for removing the broken stud and rehabilitating the stud bore, the pilots removably secured to the pilot port; and
a series of rotary tools corresponding to the steady pilots forming tool pairs, the rotary tools adapted for removal of the broken threaded fastener from the stud bore, and rehabilitation thereof, the series of pilot and rotary tool pairs comprising:
an end mill and cooperating milling pilot for flat or concave milling of the end of the broken threaded fastener;
a drill bit and cooperating drilling pilot for drilling the end of the broken threaded fastener; and
a tap and cooperating threaded tapping pilot to form new threads in the cylinder head.

2. The tool of claim 1 wherein:
the drill forms and oversize stud bore; and
the tap forms oversized threads for installation of a coiled insert into the oversize stud bore.

3. The tool of claim 1 wherein the alignment block is an elongate member extending at least a portion of a length of the cylinder head.

4. The tool of claim 3 wherein the alignment block comprises:
a short elongate member having at least three holes along its length, two holes being adapted for securing to two intact studs or stud bores, and one hole acting as a pilot port for aligning over the broken threaded fastener.

5. The tool of claim 3 wherein the alignment block comprises:
a full length elongate member having holes spaced along its length and corresponding to all stud bores along the cylinder head wherein at least two holes being adapted for securing to two intact studs or stud bores, and one hole acting as a pilot port for aligning over the broken threaded fastener.

6. The alignment block of claims 4 and 5 wherein the holes and pilot ports along its length are of a pattern that matches a stud pattern of a Chevrolet 350 cylinder head.

7. A process for removal of a broken threaded fastener in a stud bore of a cylinder head, and rehabilitation thereof, the process comprising the steps of:
removing an exhaust manifold to reveal the broken threaded fastener and the intact studs or stud bores;
fitting an alignment block over at least two intact studs or stud bores, and securing the alignment block over at least two studs or stud bores in the cylinder head for aligning a pilot port over the broken threaded fastener;
installing a milling pilot to the pilot port and milling using a cooperating end mill for flat or concave milling of the end of the broken threaded fastener;
installing a drilling pilot to the pilot port and drilling using a cooperating drill bit to remove the stud and threads for drilling the end of the broken threaded fastener;
installing a tapping pilot to the pilot port and tapping the stud bore using a cooperating tap to form new threads in the stud bore; and
fitting a replacement stud into the rehabilitated stud bore.

8. The process of claim 7 wherein after tapping the stud bore further comprising inserting a coiled insert into the stud bore, the coiled insert having outer threads matching the new threads and having inner threads matching a replacement stud.
